(19) United States
(12) Patent Application Publication
(10) Pub. No.: US 2007/0173211 A1
(43) Pub. Date: Jul. 26, 2007

(54) Optical communication device

(76) Inventors: Travis K. Liermann, Naples, ID (US); Laree C. Liermann, Naples, ID (US); Bradley Navarro, Bonners Ferry, ID (US); Kelly Navarro, Bonners Ferry, ID (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/336,444

(22) Filed: Jan. 20, 2006

(51) Int. Cl. H04B 1/38

(52) U.S. Cl. 455/90.3

(57) ABSTRACT

In one of many possible embodiments, an apparatus is provided that includes a main body; and a plurality of visual indicators coupled to said main body, said visual indicators including at least one directional command indicator.

### TECHNICAL FIELD

The present disclosure relates to optical communication devices for use in outdoor recreational settings, such as optical communication devices for use in hunting.

### BACKGROUND

In many parts of the world, hunting is a popular pastime. Big game hunting is of particular interest. Many species of big game are wary of the unfamiliar sights, sounds, and smells inherent to human. Thus, care is taken to blend into native surroundings. For example, hunters often employ camouflage when possible, make use of scent-masking techniques, and attempt to move as quietly as possible.

The desire to blend in as closely as possible to the native environment is often countered by the desire of multiple hunters to communicate with each other. Often, several people cooperate in a hunt to improve their odds of achieving a successful harvest. For example, a hunter unfamiliar with a given region will frequently contact a local guide. In such cases, it may be desirable for a guide to be able to communicate with a hunter while the hunter is stalking game. While stalking, particularly in archery or muzzle-loader applications, the animal is usually in relatively close proximity to the hunter. Similar circumstances may be present while hunting turkey or other such game. Under such circumstances, the desirability of communication between the guide and the hunter is enhanced by the consequences of ill-advised movements.

For example, while stalking, the hunter often tries to remain behind cover relative to the animal. While the cover reduces the possibility the animal will see the hunter, it also reduces the hunter's ability to see the animal. Often, the guide may have the ability to see both the hunter and the animal, and thus be in a position to advise the hunter which approach to take to improve the position of the hunter relative to the animal. Similarly, the guide is often in a better position to advise the hunter as to when to shoot, call, or otherwise interact with the animal.

Past approaches have made use of audio communication. Some approaches were as simple as guide whistling or whispering to advise the hunter how to proceed. When whispering or whistling, the hunter often alerted the animal aware of their presence. More recent approaches have made use of two-way radios. While quieter than whistling or whispering, the audible noise of the system also alerted animals to a hunter's presence.

### SUMMARY

In one of many possible embodiments, an apparatus is provided that includes a main body; and a plurality of visual indicators coupled to said main body, said visual indicators including at least one directional command indicator.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 illustrates a visual communication system according to one exemplary embodiment.

FIG. 2 illustrates an exploded view of a visual communication device according to one exemplary embodiment.

FIG. 3 illustrates a face-plate configuration according to one exemplary embodiment.

FIG. 4 illustrates a face-plate configuration according to one exemplary embodiment.

Throughout the drawings, identical reference numbers designate similar, but not necessarily identical, elements.

### DETAILED DESCRIPTION

A visual communication system is provided herein for use in outdoor applications, such as hunting applications. The visual communication includes a plurality of visual communication device. Each visual communication device may be configured to send and/or receive visual directional commands and at least one hunting specific commands. Such devices allow multiple parties to communicate while minimizing the possibility that such devices will disturb the game being sought.

In the following description, for purposes of explanation, numerous specific details are set forth in order to provide a thorough understanding of the present method and apparatus. It will be apparent, however, to one skilled in the art that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

### Visual Communication System

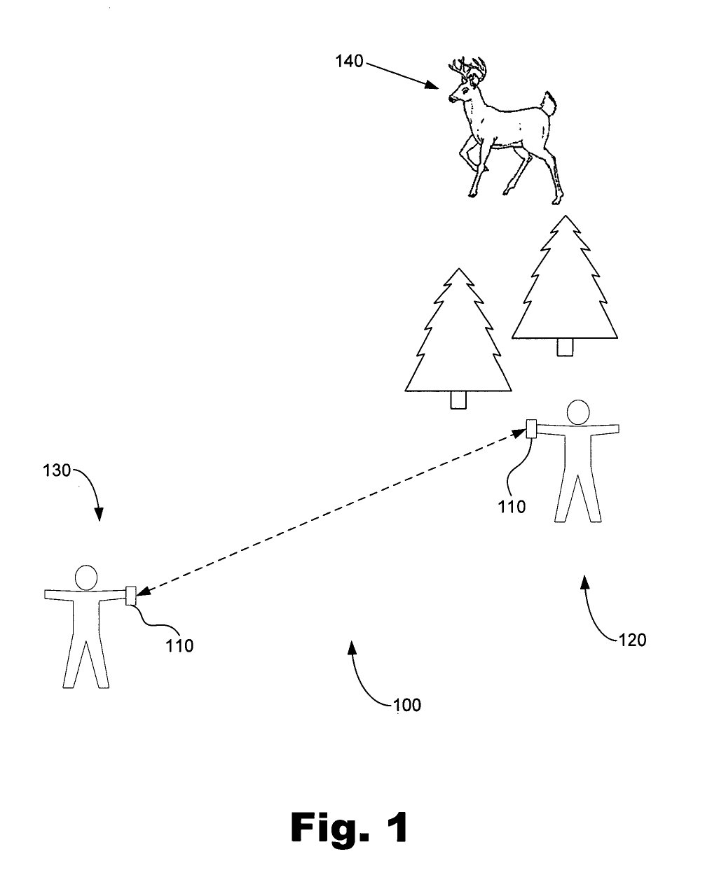

FIG. 1 illustrates a schematic view of the operation of the optical communication system. As seen in FIG. 1, the optical communication system (100) includes a plurality of optical communication devices (110). Each optical communication device (110) may be either a one-way or a two-way device, as will be described in more detail below. For ease of reference, each device (110) will be described with reference to a two-way communication device. Each communication device (110) is configured to communicate with another communication device(s) by sending and receiving communications from other communication devices.

When a sending device communicates with a receiving device, the receiving device produces a non-audio signal, such as a command or an alert. For ease of reference, all non-audio commands and alerts shall be collectively referred to as non-audio signals. According to several exemplary embodiments, the non-audio signals include the selective activation of lights and/or vibration.

These non-audio signals allow communication between a hunter (120) and another person (130), such as a guide, another hunter, or other person. For convenience, the current exemplary embodiment will be discussed with reference to a guide (130) communicating with the hunter (120) while the hunter (120) is stalking game, such as an animal (140). Other situations and configurations are possible, as will be appreciated by those of skill in the art.

While the hunter (120) stalks the animal (140), the guide (130) may be able to observe the movements of both the hunter (120) and the animal (140). At some point, it may be desirable for the guide (130) to alert the hunter (120) that communication is desired. According to one exemplary embodiment, the guide (130) is able to send an alert to the hunter (120) from the guide's (130) communication device to the hunter's communication device. The alert may include vibrating the communication device and/or a visual signal such as a light.

Once the hunter (120) has been alerted, the guide (130) may use his communication device to provide visual commands to the hunter (120). Those of skill in the art will appreciate that the visual commands may be provided without the guide (130) alerting the hunter (120). In any case, the visual commands may include visual commands as to which direction the hunter (120) should move or whether the hunter (120) should maintain his position. The visual command may also include a hunting-specific command. As used herein, hunting-specific command shall be broadly understood to mean any command specifically adapted to the harvesting of any game animal, bird, or fish. Hunting-specific commands include, without limitation, shoot, kill, and harvest. Hunting-specific commands may include game-specific commands. Game-specific commands may include, without limitation, commands to imitate calls or noises commonly made by game. Exemplary noises may include a bleat, bugle, rattle, gobble, snort, stomp, cow call, hen call, etc.

### Optical Communication Device

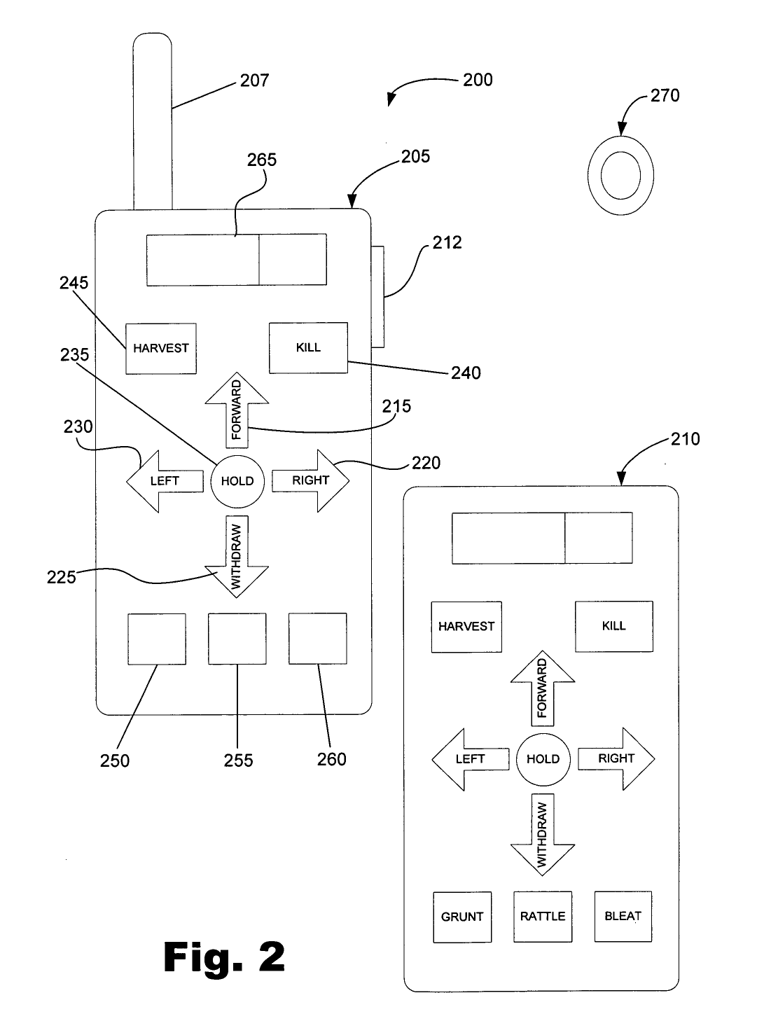

FIG. 2 is an exploded view of a visual communication device (200) according to one exemplary embodiment. As shown in FIG. 2, the visual communication device (200) includes a main body (205) and a face plate (210). The face plate (210) may be a removable face plate, such that the face plate may be selectively coupled to and removed from the main body (205). As will be discussed in more detail below, multiple face plates may be provided with the visual communication device (200) to allow the device to be used in taking any type of game.

Each visual communication device (200) is configured to communicate with one or more different visual communication devices. According to one exemplary embodiment, the visual communication device (200) includes an antenna (207) coupled to the main body (205). The antenna (207) is configured to both transmit outgoing signals to other visual communication devices (200) and to receive incoming signals from other communication devices, as is well known in the art. Accordingly, activating a button or other indicator on the visual communication device (200) causes a desired response in a separate visual communication device (200) and vice versa.

The visual communication device (200) may include an alert button (212) coupled to the main body (205). The alert button (212) causes another visual communication device to produce a primarily non-audible alert. According to one exemplary embodiment, a non-audible alert may include vibration of the visual communication device (200) and/or other primarily non-audible types of notification, such as illumination of one or more indicators discussed below.

The visual communication device (200) also includes a plurality of indicator buttons coupled to the main body (205). These indicator buttons may include a plurality of directional indicators, such as a forward indicator (215), a withdraw indicator (225), a move left indicator (230), a move right indicator (220), and a hold position or stop indicator (235). Each of these indicators may be selectively activated by a separate communication device (200) to instruct the user as to which direction, if any, to move. Each directional indicator may have corresponding text associated therewith. For example, the advance indicator (215) may have “FORWARD” or other similar text located thereon or on the main body (205) near thereto. Similarly, the withdraw indicator (225) may have “WITHDRAW” or other similar text located thereon or on the main body (205) near thereto. Such text may clarify which command is being given, and thus may be referred to as instructional text.

In particular, according to one exemplary embodiment, depressing or otherwise activating a directional indicator on one device activates a corresponding directional indicator on another device. That indicator then provides a visual response, such as by lighting up. The hunter (120; FIG. 1) is then able to note which indicator is activated, read the instructional text associated therewith, and thus receive a command.

At times, it may be desirable for the sender of the command, such as the guide (130; FIG. 1) to notify the hunter (120; FIG. 1) that communication is desired. For example, if the guide (130; FIG. 1) desired to instruct the hunter 120; FIG. 1) to advance, the guide (130; FIG. 1) may first alert the hunter (120; FIG. 1), as previously discussed. The hunter (120; FIG. 1) may acknowledge the alert by sending an alert back to the guide (130; FIG. 1). The guide (130; FIG. 1) may then activate the advance indicator (215), such as by pressing it. The advance indicator (215) on the hunter's device would then be activated, such as by lighting up. The hunter then reads the desired command sent by the guide (130; FIG. 1) by noting which indicator is lighted up. As a result, the visual communication device (200) allows one user to provide and/or receive non-audio directional commands.

The visual communication device (200) also allows a user to send and/or receive hunting-specific commands. According to one exemplary embodiment, a visual communication device (200) also includes at least one hunting-specific command indicator. In the present exemplary embodiment, five separate hunting-specific command indicators are shown. According to the present exemplary embodiment, the five hunting-specific command indicators include first, second, third, fourth, and fifth hunting-specific command indicators (240, 245, 250, 255, and 260). Those of skill in the art will appreciate that any number of hunting-specific command indicators may be used.

The exemplary visual communication device (200) of FIG. 2 sends and/or receives hunting-specific commands in a similar manner as the visual communication device (200) sends and/or receives directional signals. In particular, to provide hunting-specific commands, a user activates the desired hunting-specific command indicator. Activating the desired hunting-specific command indicator causes the visual communication device to send signals to other visual communication devices. The receiving visual communication device then activates the corresponding hunting-specific command indicator in response to the signals. Activation of a hunting-specific command indicator may cause the indicator to light up and/or vibrate. Each hunting-specific command indicator may also have corresponding text associated therewith, such as text on or near the indicator.

The text associated with each hunting-specific command indicator may correspond to different hunting-specific commands. For example, according to one exemplary embodiment, the first hunting-specific command indicator (240) may have the text “KILL” or “SHOOT” associated therewith. Such a command may be provided when the guide (130; FIG. 1) determines that the hunter (120; FIG. 1) is in a suitable position to initiate a shooting sequence. In such a situation, the hunter (120; FIG. 1) would notice that the first hunting-specific command indicator (240) is activated and note that the corresponding “KILL” or “SHOOT” text associated therewith. As a result, the hunter (120; FIG. 1) would understand that a kill or shoot command is being communicated.

Additionally, each kill or shoot hunting specific command indicator (240) may be used by the hunter (120; FIG. 1) to communicate to the guide (130) that the hunter (120; FIG. 1) is prepared to shoot. Under such circumstances, when the guide (130) receives the kill command communication from the hunter (120), the guide may act to cause the game to pause or hold. For example, when receiving the kill command, the guide (130) may whistle or make other subtle noises to cause the game to stop to listen to the noise. Thereafter, the hunter (120) may initiate or finish the shooting sequence while the game is thus distracted.

The second hunting-specific command indicator (245) may have the text “HARVEST” associated therewith. Such a command may be provided when the guide (130; FIG. 1) has determined that the game has been successfully taken. In particular, the second hunting-specific command indicator (245) may be activated, as previously discussed. During the stalk and after the ensuing shot, the guide (130; FIG. 1) may be located in a better position to guide the hunter (120; FIG. 1) to the game. For example, after being shot, game usually flees. In such circumstances, the hunter (120; FIG. 1) may lose track of the final location of the game as the hunter (120; FIG. 1) makes his way toward the direction where the game was shot. In many cases, the guide (130; FIG. 1) may remain stationary and thus not be distracted by finding his way across rough terrain to the game. In such a case, the guide (130) may notify the hunter (120; FIG. 1) that the stalk is complete, to begin the harvest, and thereafter to provide directional commands as previously discussed.

According to one exemplary embodiment, the directional indicators, as well as the kill and harvest indicators, and the text associated with each may generally be considered as standard. The third, fourth, and fifth hunting-specific command indicators (250, 255, 260) may be configured to provide game-specific commands. As used herein, game-specific commands shall be broadly understood to mean any hunting-specific command that may be specifically adapted for a particular type of game. For example, game-specific commands may include text associated therewith adapted for taking deer, elk, turkey, or any other type of game.

According to one exemplary embodiment, the third, fourth, and fifth hunting-specific command indicators (250, 255, 260) may have default text associated therewith. Such default text may be considered as default text if it is on the main body and/or the indicators. Any suitable default text may be provided as desired.

According to another exemplary embodiment, the instructional text associated with each indicator, and to the third, fourth, and fifth game-specific indicators in particular, may be associated with the face plate (210). The face plate (210) is configured to be removably coupled to the main body (205). Further, the face plate (210) may have a plurality of generally transparent portions that allow some portion of light generated by the indicators to pass therethrough. According to one exemplary embodiment, the face plate (210) may have at least one transparent portion corresponding with at least one indicator. For example, specific instructional text may be associated with each light-transmitting portion, such that as each hunting-specific command indicator is activated, a user is able to view the text associated therewith and thus receive hunting-specific commands.

The face plate (210) also includes game-specific instructional text. For example, as shown in FIG. 2, a face place configured for deer hunting may include text such as “GRUNT” associated with the transparent portion of the face plate corresponding to the third hunting-specific command indicator (250). Additionally, the text “RATTLE” may be associated with the fourth hunting-specific command indicator (255). Further, the text “BLEAT” may be associated with the fifth hunting-specific command. Such a configuration is for illustrative purposes only. Any type of text, including game-specific instructional text may be provided at any number of locations on the face plate (210).

To this point, instructional text has been discussed with reference to hunting- and/or game-specific commands. Other instructional information may be provided with the main body (205) and/or each face plate (210) by the shape of the indicators and/or the shape of the transparent portions associated with each transparent portion. For example, an antler-shaped transparent portion (265) may be associated with the fourth hunting-specific command indicator (255), such that when the fourth hunting-specific command indicator (255) is activated, a user would see the antler-shaped transparent portion (265) illuminated and thus know that a rattle command had been sent.

### Additional Face Plate Configuration

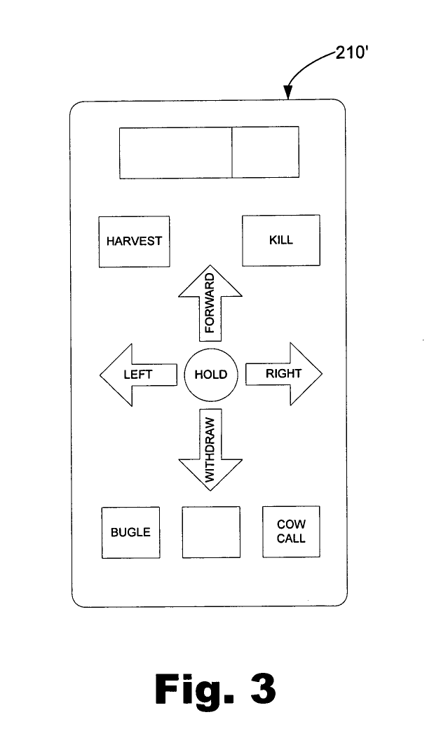

FIG. 3 illustrates a face plate (210′) configured for use in hunting elk. The present exemplary face plate (210′) includes the text “BUGLE” at a location corresponding to the third hunting-specific command indicator (250; FIG. 2). The face plate (210′) also includes the text “COW CALL” at a location corresponding to the fifth hunting-specific command indicator (260). The face plate (210′) may be selectively coupled to the main body (205; FIG. 2) as desired, thereby allowing the visual communication device (200; FIG. 2) to be adapted for multiple types of hunting.

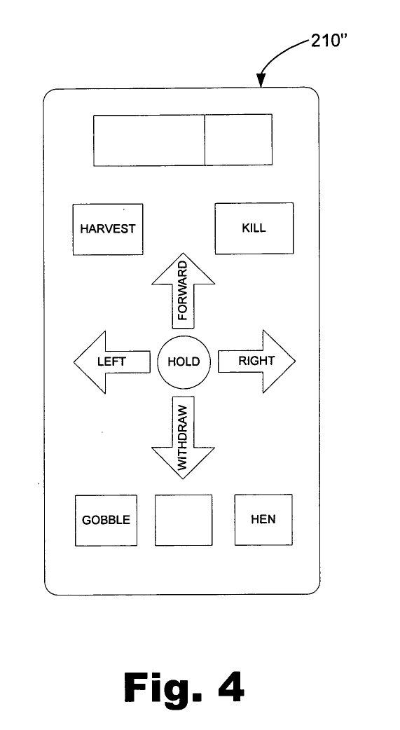

Any number of face plates may be provided. In another exemplary embodiment shown in FIG. 4, a face plate (210″) may be provided for hunting turkey. Such a face plate may (210″) have text at locations for providing game-specific information for hunting turkey. In particular, the exemplary face plate (210″) illustrated in FIG. 4 includes the text “GOBBLE” to be associated with the third hunting-specific command indicator (250; FIG. 2) and the text “HEN” to be associated with the fifth hunting-specific command indicator (260).

While three different face plates have been illustrated and described as having certain configurations, those of skill in the art will appreciate that any number of face plates may be provided with any number of configurations. For example, those of skill in the art will appreciate that face plates may be provided which do not cover substantially the entire face of the main body.

The visual communication device (200) is configured to provide time and/or compass information. This information may be displayed by a display screen (265) coupled to the main body (205). While date and compass information is discussed as being displayed on the display screen (265), those of skill in the art will appreciate that various types of information may also be displayed by the display screen. Additional configurations and components may also be included with the main body. As shown in FIG. 5, the visual communication device (200) may be configured to be coupled to any number of objects. In addition, it may be desirable to have one or more indicator separated from the main body (200). As shown in FIG. 2, the visual communication device (200) may have a supplemental kill button (270). The supplemental kill button (270) may be readily attached as desired to any suitable object. For example, as shown in FIG. 2, the supplemental kill command indicator (270) may be attached to or near the sights used on the weapon used by the hunter. As shown in FIG. 5, the kill button (270) is coupled near the sights of a bow. Further, the kill button (270) may be adapted to illuminate other types of sighting systems, such as the sights of a shotgun or rifle, including illuminating the front and/or rear sights of a weapon with open sights or illuminating the cross hairs or some other portion of an optical sight system, such as a scope. Additionally, the supplemental kill button (270) may be placed such that the hunter (120; FIG. 1) may readily depress the kill button (270) so that a guide may distract the game, as previously discussed.

While a single kill command indicator is described, those of skill in the art will appreciate that any number or type of supplemental indicators may be used. Each indicator may have a power source coupled thereto, such as a battery or other device or may be powered remotely, either by a wire or other direct contact or wirelessly, as is well known to those of skill in the art.

A visual communication system is provided herein for use in outdoor applications, such as hunting applications. The visual communication includes a plurality of visual communication device. Each visual communication device may be configured to send and/or receive visual directional commands and at least one hunting specific commands. Such devices allow multiple parties to communicate while minimizing the possibility that such devices will disturb the game being sought.

The preceding description has been presented only to illustrate and describe exemplary embodiments. It is not intended to be exhaustive or to limit the disclosure to any precise form disclosed. Many modifications and variations are possible in light of the above teaching. It is intended that the scope of the disclosure be defined by the following claims.

What is claimed is:

1. A communication device, comprising:
a main body; and
a plurality of visual indicators coupled to said main body, said visual indicators including at least one directional command indicator.

2. The device of claim 1, wherein said visual indicators further include at least one hunting specific command indicator.

3. The device of claim 1, further comprising a removable face plate.

4. The device of claim 3, wherein said removable face plate includes text associated therewith to provide hunting specific commands in cooperation with said visual indicators.

5. The device of claim 4, wherein said hunting specific commands include game specific commands.

6. The communication device of claim 1, wherein said visual indicators are configured to light up.

7. The communication device of claim 1, further comprising an alert button, said alert button being configured to send an alert communication to other communication devices.

8. The communication device of claim 1, wherein said device is configured to vibrate in response to receiving an alert communication.

9. The communication device of claim 1, further comprising at least one supplemental indicator, said supplemental indicator being separated from said main body.

9. A communication device, comprising:
a main body,
at least one visual directional command indicator coupled to said main body, said visual directional command indicator being configured to send and receive visual directional commands; and
at least one hunting specific command indicator coupled to said main body, said hunting specific command indicator being configured to send and receive visual hunting specific commands.

10. The communication device of claim 9, further comprising a plurality of visual directional command indicators, said indicators being configured to light up when receiving directional commands.

11. The communication device of claim 9, further comprising a plurality of visual directional command indicators including advance, withdraw, move left, move right, and hold visual command indicators.

12. The communication device of claim 9, further comprising at least one face plate configured to be selectively coupled to said main body, said face plate including text related to at least one hunting specific command associated therewith.

13. The communication device of claim 12, wherein said face plate includes text related to at least one of game specific instruction for deer, elk, or turkey.

14. The communication device of claim 9, further comprising a supplemental hunting specific command indicator, said supplemental hunting specific command indicator being separated from said main body.

15. The communication device of claim 14, wherein said supplement hunting specific command indicator comprises a shoot hunting specific command indicator.

16. The communication device of claim 9, wherein said device is configured to illuminate said visual directional command indicator to receive said visual directional command.

17. The communication device of claim 9, wherein said device is configured to illuminate said visual hunting specific command indicator to receive said visual hunting specific command.

18. A communication device, comprising:
means for sending visual directional and hunting specific commands; and
means for receiving visual directional and hunting specific commands.

19. The communication device of claim 18, further comprising means for displaying at least one of temperature, time, or compass information.

20. The communication device of claim 18, further comprising means for selectively providing a plurality of game specific command information.
